(19) United States
(12) Patent Application Publication
(10) Pub. No.: US 2004/0058821 A1
(43) Pub. Date: Mar. 25, 2004

(54) Ionically balanced polyacrylamide composition

(76) Inventors: Mickey Brigance, Germantown, TN (US); Greg McManic, Germantown, TN (US)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/621,130

(22) Filed: Jul. 16, 2003

Related U.S. Application Data
(60) Provisional application No. 60/396,150, filed on Jul. 16, 2002.

(51) Int. Cl. A01N 25/10

(52) U.S. Cl. 504/361

(57) ABSTRACT

An ionically balanced composition for applying to soil or plants containing an aqueous solution or dry mixture of at least one nonionic acrylamide polymer and an ionically balanced diluent.

### REFERENCE TO A RELATED APPLICATION

The benefit of provisional patent application No. 60/396,150, filed Jul. 16, 2002, is claimed and incorporated herein by reference.

### INTRODUCTION AND BACKGROUND

The present invention relates to an ionically balanced polyacrylamide composition which exhibits enhanced performance properties such as compatibility with ionic and particularly highly cationic pesticide systems, improved electrolyte tolerance, and broadened systemic potentiation of pesticides while maintaining typical deposition and anti drift characteristics. The composition may be in the form of a powder, water solution, dispersion or reverse phase emulsion.

It is well known in agriculture to apply various agrochemicals to growing areas by spraying. The growing areas may be crop areas, which can be very large, or smaller growing areas such as those in greenhouses. The agrochemicals applied as sprays include fertilizers, herbicides and pesticides.

It is well recognized by the agricultural industry that it is advantageous to the end-users to be able to formulate dry agricultural chemicals such as fertilizers, pesticides, and/or adjuvants so that they can be easily mixed with water and applied by means of a spraying apparatus to a target area.

Fertilizers can be supplied in various forms, in particular as solid compositions, or as suspensions or solutions of the fertilizer in a liquid. Fertilizer solutions are generally supplied by the manufacturer as an aqueous concentrate in large batches of size around 1 ton in weight. The solutions contain high concentrations, often 10 to 80 wt. % (dry solids), of dissolved inorganic fertilizer.

Dry and liquid adjuvants and fertilizers are available to both the agricultural and nonagricultural markets, and each type of product has its advantages and disadvantages. For example, dry adjuvants and fertilizers have the advantages of containing a high concentration of active ingredients, and the ability to incorporate various ingredients into the composition to increase the efficacy of the composition. However, many dry adjuvants and fertilizers have a disadvantage in that they must be dissolved before use, which can be hazardous and require substantial mixing and long dissolving times.

Herbicides and pesticides can be supplied to the farmer in various forms, for instance as neat liquids, aqueous solutions, aqueous dispersions or slurries of solid herbicide or pesticide. It is normal practice for the manufacturer to supply the farmer with the herbicide or pesticide in the form of a neat liquid or as a high activity solution or slurry. The usual way of applying herbicides or pesticides to an area of land would be by spraying.

Various systems have been devised for convenient dosing of fertilizers, herbicides or pesticides. Spray pumps are well known which spray water from a spray manifold onto the area of land or crop area and which are designed so that concentrated fertilizer solution, herbicide or pesticide can be dosed into the pump, mixed with water before being sprayed.

The use of dry fertilizers and adjuvants are problematic because their solubility in water varies with various water qualities throughout the United States. Water temperatures, pH, hardness, and mineral content all affect the ease of dispersing or dissolving the fertilizer and adjuvants into the spray mixture. This unpredictable solubility has been a problem for end users applying herbicides to kill weeds. The end users typically prepare herbicidal mixtures using cold water, under varying conditions, and frequently outdoors where solubility problems cannot be satisfactorily resolved. The end users then face the problem of applying a suspension of fertilizer and adjuvant in water with the herbicide. The suspension can plug conveying lines, or cause an uneven application of the fertilizer and herbicide on vegetation, which results in an uneven kill rate and directly exposes an end user preparing the solution to undesirable herbicide and fertilizer contact.

Mist, or the fine particles end of the droplet-size spectra in these agricultural sprays, i.e., those less than about 150 microns in diameter, often reduce the effectiveness of the chemical delivery process.

When the agricultural sprays are to be directed onto a specific target, the aerial spray or discharge delivery systems are typically mounted on airplanes, tractors, or ground equipment. However, as a result of spray drift, much of the active chemical ingredients in a spray can be rendered ineffective or lost because of the inability of the small diameter spray or mist particles to reach an impact upon the intended target, i.e., the crop or field locus. While small droplets provide better coverage of a target, they are more susceptible to drift than larger droplets. Spray drift represents a loss of agricultural chemical from intended targets and thus results in dangers inherent in air, ground, and water pollution. Since off-target agricultural chemicals are wasted product and can have a negative environmental and economic impact, especially if the agricultural spray medium contains fertilizer and most especially if the medium contains pesticide, it is in the interest of all for sprayers to reduce this drift induced problem.

For some applications it is common practice to combine two or more agrochemicals. For instance in the application of herbicides, especially systemic herbicides, it is convenient to combine the treatment with a fertilizer, such as for instance ammonium sulphate. The fertilizer stimulates the growth of unwanted plants causing them to take up more water, together with the herbicide, through the root system. This ensures a more efficient uptake and distribution of herbicide throughout the plant. In this instance the fertilizer may be regarded as an adjuvant in that it increases the efficacy of the herbicide. Thus a fertilizer used in combination with a herbicide is termed a herbicide adjuvant.

During the spraying of fertilizers, herbicides and pesticides it is usual to apply anti-drift agents in order to prevent the formation of fine droplets which could be carried beyond the area intended to be treated. Without the use of anti-drift agents, the spraying of fertilizers, herbicides and pesticides would be inefficient, for the reason that, first of all because there could be inadequate treatment of the land and crop areas intended to be treated and secondly the extraneous spray, if carried beyond the intended treatment zone, could for example be detrimental to other crops, land and water courses.

It is usual to combine the anti-drift agent with either the water which is fed into the spray pumps or to apply it directly into the spray pumps, usually at or shortly after the mixing zone where the water is mixed with the herbicide, pesticide or aqueous fertilizer concentrate. It is important that the spray drift chemical is metered at the correct dose to ensure that extraneous spray is not formed through underdosing or through overdosing if the spray angle is too narrow resulting in uneven distribution of the pesticide, herbicide or fertilizer.

In addition, significant differences in particle sizes between the individual components in a dry product can result in particle separation during shipping and/or storage. This leads to a nonhomogeneous composition which, if applied without remixing, can lead to poor results or cause damage to treated vegetation. Furthermore, inherent tackiness or particle fines generated through attrition can result in compaction and/or caking before the end user applies the dry adjuvant and fertilizer.

Liquid adjuvants and fertilizers overcome the disadvantages of long dissolving times and particle separation. But, due to solubility limitations, liquid adjuvants and fertilizers are limited in the number and amount of components present in the liquid composition. In addition, incompatibilities between different composition components makes several liquid fertilizer compositions impossible to manufacture or store for extended time periods.

The inability to solubilize high percentages of active components in a liquid adjuvant or fertilizer is a major disadvantage. In particular, concentrated liquid adjuvants and fertilizers are required to avoid the high cost of shipping large amounts of water. Concentrate liquid adjuvants and fertilizers also have the problem of phase stability because solid components tend to precipitate or settle from the composition, or liquid components tend to form separate liquid phases.

In many farming areas, soil is deficient in one or more of the natural nutrients required for satisfactory growth of certain crops. As a result, such crops do not give their optimum yield. When such conditions exist, it is a common procedure to apply a fertilizer rich in the required nutrients(s). The most common fertilizers in use today are the water-soluble, nitrogen-containing fertilizers. Solutions of the fertilizers are usually applied to the crop locus via aqueous spraying techniques; and, as described above, this spraying process usually results in the attendant product of fine mist and droplet drift.

One solution proposed in the art to reduce mist and chemical drift in aqueous agricultural sprays, such as those containing fertilizers, is to incorporate into the aqueous medium a viscosity-increasing amount of a guar gum or derivative of guar gum, specifically non-derivatized guar gum, non-cationic derivatized guar gum, cationic guar gum, or mixtures thereof.

For both dry and liquid adjuvants and fertilizers, it is desirable to incorporate several different ingredients, in a high concentration (if needed), into a single composition. For example, it is desirable to incorporate a fertilizer component, an adjuvant, a spreader-sticker (i.e., a deposition aid), a drift control agent, an antifoaming agent, and a pesticide (if desirable) into a single product. A single, multipurpose composition eliminates a need for the end user to inventory a large number of different chemicals. In addition, application of the chemicals is made easier and less hazardous, with a reduced chance of misapplication, because only one product is measured, dissolved, and applied. Combination adjuvants and fertilizers also are more environmentally friendly because fewer empty containers are generated, and fewer chemical containers are stored for long periods.

When an adjuvant is used in conjunction with an herbicide, a barrier to maximizing herbicide performance, especially at the lowest possible labeled use rates, is the application technique itself. In an effort to ensure the herbicide is applied within intended boundaries (i.e., does not drift), conventional sprayers utilize nozzle tips that produce large spray droplets. Research has shown that these large droplets are not retained by many species of vegetation, and, consequently, herbicide efficacy is reduced.

Attempts have been made to include various polymers with the fertilizer in a liquid formulation to improve the solubility and dispersibility of the fertilizer in water of a wide quality range. Unfortunately, some commonly used polymers and other organic substances, such as xanthan gum, have not been completely successful in solubilizing or dispersing efficacious concentrations of fertilizers in an aqueous solution.

Polymers of acrylamide and other ethylenically unsaturated monomers have been used as anti-drift agents. It has been generally accepted that polymers which give optimum spray drift control are either non-ionic (e.g. acrylamide homopolymer) or have relatively low anionic content (e.g. 5 to 30 wt. %) and also have relatively high intrinsic viscosity, for instance above 6 dl/g. Such polymers tend to form viscous aqueous solutions unless used at low concentration. Normal practice is to mix the polymer powder or reverse phase emulsion form with water directly into the spray tank so as to form an aqueous solution of polymer. However, this has the problem that emulsion polymers can be difficult to activate in this situation and polymer powders take a long time to dissolve. It is sometimes necessary to use more polymer as a result of inefficient dissolution of the polymer. Normally in order to minimize the problems with dissolution it would be usual to use polymers of intrinsic viscosity in the range 6 to 15 dl/g. Typically the water containing the pesticide, herbicide or fertilizer would comprise polymer at a concentration in excess of 0.05 wt. %.

When the concentrate is a solution in water or organic solvent, it is very rare to include polymeric material. However when the concentrate is a dispersion in water it is common to include a small amount of polymeric thickener and when the concentrate is a dispersible grain it is common to include a small amount of polymeric binder. A wide variety of polymers have been mentioned in the literature as thickeners and binders (for instance the cellulosic, acrylamide, vinyl alcohol and other polymers proposed in U.S. Pat. No. 4,657,781) but in practice very few polymers have been used. For instance the thickener is almost always xanthan gum. The thickeners and binders used in agricultural concentrates generally have high molecular weight, in order that they can impart the desired thickening or binding effect. They are generally present in a minor amount relative to the active ingredient, for instance less than 0.1 parts polymer per part by weight active ingredient.

Research efforts to reduce spray drift have typically dealt with improved equipment design, e.g., nozzle design to optimize spray patterns, or application techniques such as spray pressures, heights, formulations, etc. The most promising improvements in the application technology area have been in the reduction of fine spray droplets in the droplet spectrum during atomization via the use of spray modifiers known as drift control agents. Effective drift control agents must possess a great number of characteristics for they must be able to increase the small droplet size; be insensitive to the high shear process conditions realized in the spray system pumps, nozzles, etc.; not detract from the biological effects of the spray bioactives; be compatible with other spray adjuvants, i.e., non-bioactive material added to the spray mixture to improve chemical or physical characteristics; not separate upon standing; be easy to use; be environmentally friendly; and be cost efficient.

Drift control agents are usually high molecular weight polymers which, when added to aqueous systems, tend to increase the viscosity of the system and thus prevent the water from being broken up into a fine mist when aerially sprayed or discharged.

These high molecular weight polymers tend to be unstable in that they often degrade upon aging and are very shear sensitive; both of which conditions, upon occurrence, cause a decrease in solution viscosity with a concomitant decrease in drift control activity.

In U.S. Pat. No. 4,126,443 a very small amount of low molecular weight hydrolyzed acrylamide is incorporated into an aqueous concentrate of a particular herbicide in order to prevent crystallization within the concentrate. The polymer is formed of 50 to 99% acrylic acid groups and 1 to 50% acrylamide groups and is present in the concentrate in an amount that is recommended to be below 640 ppm (0.064%) although in one example the amount is 0.5%. The amount of active ingredient in the concentrate is from 20 to 40% and so when this is diluted to form a sprayable composition the concentration of polymer in the sprayable composition will be only a few parts per million.

It is also known to include polymers in the agricultural composition that is to be applied, so as to modify the properties of that composition. For instance in EP-A-55857 a particular carbamate insecticide is blended with an excess of various film-forming polymers and applied as a film from an ethanol solution, and it is suggested that the effect of the polymer is to alter the crystallization properties of the carbamate when the solvent evaporates and a film is formed. There is no suggestion that the solution should be sprayed and the carbamate is not a foliar systemic active ingredient. Indeed the teaching in this patent (to adjust the crystallization properties) is clearly unrelated to systemic activity which requires absorption of the active ingredient, presumably while still in the liquid phase, through the leaves into the plant. The preferred polymers in EP 55857 are said to be water soluble cellulose derivatives but polyacrylamides, ethylene oxide resins and water insoluble polyamides, esters and other polymers are mentioned including very high molecular weight polyethylene oxide. Since the compositions are cast as a film, it is clear that the polymer will have a major effect on the properties of the film and on the properties of the solution before drying.

U.S. Pat. No. 6,364,926 discloses a concentrated liquid adjuvant and fertilizer composition containing a nitrogen source, an ampholytic surfactant, a drift control agent/deposition aid, and a carrier in a single phase stable package.

U.S. Pat. No. 6,288,010 discloses a composition comprising a water solution of an inorganic water soluble compound such as ammonium sulfate of at least 10% by weight and an anti drift agent which is a water soluble anionic polymer of intrinsic viscosity at least 6 dl/g.

U.S. Pat. No. 5,964,917 relates to dry processing nitrogen fertilizers with guar gum, starch encapsulated silicone defoamer, and dedusting agent such a nonyl phenol ethoxylate.

U.S. Pat. No. 5,550,224 relates to use of guar, including both non derivatized and cationic guar, as a drift control agent at use levels in the spray mix of 10 to 37 oz. per 100 gallons (0.075 to 0.276% weight per unit volume). These polymers are non-viscoelastic which is different from polyacrylamides, high mole weight polyethyleneoxides, and polyvinylpyrrolidones in that guar in not sensitive to shear stress.

U.S. Pat. No. 5,874,096 is a continuation of U.S. Pat. No. 5,550,224. Major difference is reduction of use rates to a range of 1.4 to 17 oz per 100 gallons spray mix of modified and natural guar.

U.S. Pat. No. 5,824,797 discloses a method for improving deposition characteristics by using guar to increase in placement of spray onto target which increases bioefficacy and efficiency of the spray.

U.S. Pat. No. 5,525,575 relates to systemic activity of pesticide systems which can be enhanced by incorporating water soluble polymers such as nonionic polyacrylamides of sufficiently low molecular weight as to have little or no effect on the diluted herbicide spray pattern. The composition may exist as a reverse phase emulsion or dispersion, water soluble solution, or powder.

U.S. Pat. No. 5,529,975 shows that systemic activity of pesticide systems can be enhanced by incorporating water soluble polymers such as nonionic polyacrylamides of a high molecular weight so as not to effect the spray pattern of the diluted herbicide spray. The composition exists as a reverse phase emulsion or dispersion.

U.S. Pat. No. 4,510,081 shows use of dual polymer system to develop a drift control concentrate. Polymer 1 mentioned is derived from a group of polysaccharides such as xanthan, guar, starch, cellulose gums, and the like, is a water thickener and is not viscoelastic. Polymer 2 forms a viscoelastic solution in water and is derived from several chemical groups including polyacrylamide (nonionic and anionic) polymers. Use rates of formulated product range from 1 to 30 oz per 100 gallons spray and function as an anti drift agent. Examples cited are oil based formulations (liquid concentrates).

### SUMMARY OF THE INVENTION

The invention involves both a process and a composition for producing an ionically balanced polyacrylamide composition with enhanced performance properties.

As mentioned above, the present invention relates to an ionically balanced polyacrylamide composition that exhibits enhanced performance properties when formulated with highly cationic pesticide systems. In other words, the compositions of this invention are sufficiently neutralized to insure compatability with highly cationic pesticide formulations. Thus, the compositions of the invention include an ionically balanced composition comprising an admixture of at least one nonionic acrylamide polymer and an ionically counterbalanced diluent. The diluent can be water as for example, when the polymer is 100% nonionic as no neutralization is necessary. Or, when the polymer is not 100% nonionic then a source of nitrogen, such as an ammonium salt can be added to balance the ionic properties. Other ingredients to balance the ionic charges of the polymer could also be used in place of the nitrogen source or in addition thereto.

The process of the invention involves the following:

a) powders can be produced by controlling the particle size of an ionically counter balanced diluent (preferably a water soluble crystal such as inorganic nitrogen containing salt, e.g., ammonium sulfate, ammonium nitrate, urea, ammonium bisulfite, ammonium citrate, ammonium phosphate, etc.) to a range which is more course than a fine powder but finer than unprocessed material to form a presized fertilizer. The presized fertilizer is then sprayed with a liquid polyacrylamide or the presized powdered polyacrylamide is blended with the fertilizer until a homogeneous, dry, powdery mixture is obtained. Post adding follows with other agents such as defoamers, anti caking agents, other deposition enhancement agents, surface active agents, dispersing agents, crystalline inhibitor agents, other sequestering agents, shear resistant anti drift agents, etc. Screening out oversized particles can be carried out if necessary.

Typically, the process begins with the steps of passing the unprocessed diluent through a hammer mill (such as a 3 TH model Micropulverizer or equivalent) using either no screen or a large gapped screen such as a “jump gap” screen designed to further reduce the fertilizer particle size to a satisfactory range. In the usual case, ammonium sulfate crystals are primarily larger than 45 mesh before milling. This is too large a particle to coat with a liquid of any significant concentration because the resultant mixture will tend to be sticky and not hold up to storage without forming lumps in the bags. The resultant mixture may be difficult to pour out and may not disperse readily. By controlling the resonance time in the mill and the type of screen, ammonium sulfate or other ionically counter balanced diluents can be ground so that the majority of the particles are in the range of 40 to 100 mesh with a heavy percentage in the 55 to 85 mesh range. It is also important not to over mill the ionically counter balanced diluent which would produce significant percentages of particles less than 130 mesh as they tend to cause lumps and mill scale which do not disperse readily.

Once the ionically counter balanced diluent is milled to proper particle size it is charged into a suitable mixing device such as a ribbon blender where the other components of the composition are added. It is preferable to spray the liquid polyacrylamide emulsion/suspension first onto the ionically counter balanced diluent. The relatively large particle size of the ionically counter balanced diluent will accept the liquid spray without forming lumps or hard scale particles. This mixture is then blended until homogeneous and lump free. Other components such as those listed above are then added to the mixture and blended. The mixture may then be run through a post sifting device such as a Sweeko or Azo screen to remove any significant quantity of particles of higher than desired size.

b) According to another embodiment of the invention, a water soluble liquid may be produced by adding an ionically counter balanced diluent such as water containing ionically counter balancing agents as mentioned above and other components (defoamers, sequestering agents, surfactants, potentiating agents, humectants, other deposition or anti drift agents) into a mixing tank. A polyacrylamide compound is then dissolved into the ionically counter balanced diluent solution using a mechanical device such as recirculation pump, powder inductor, cowls type dispersator, modified sand mill or other attrition devices. The resultant mixture is then aged under constant low shear high torque agitation until the polymer is fully hydrated and free of lumps or gel droplets.

c) In yet another embodiment of the invention, a reverse phase emulsion or dispersion is produced by reacting the polymer in an ionically counter balanced diluent such as mineral, petroleum, vegetable, modified vegetable or naphthenic oil containing ionically counter balancing agents as mentioned above and forming the emulsion or dispersion by adding a variety of surfactants in the presence of water. The amount of water can be then reduced by azeotropic distillation.

The compositions for the above processes according to the present invention includes the following:

a) A polyacrylamide blend which contains one or more polyacrylamide components of various ionic charges and molecular weights. Polyacrylamide components may vary from having 0 charge and be nonionic. in nature to being primarily anionic salts of polyacrylates having charge densities up to 96%. Molecular weights may range from 50,000 to 25,000,000 or greater. The term “polyacrylamide” as used herein is intended to mean acrylamide polymers encompassing homopolymer of acrylamide and copolymers of acrylamide with other ethylenically unsaturated conomers. Nonionic polyacrylamide refers to a homopolymer of acrylamide with no ionic character. Anionic polyacrylamide refers to a co-polymer of acrylamide with an alkali metal or ammonium salt of acrylic acid. The anionic polyacrylamide can have varying degrees of anionic character from a few % to up to 95% anionic character. The differential is of course nonionic.

b) An ionically counter balanced diluent containing appropriate ionic and/or nonionic components which balance the action of the blend in 1 above to be compatible with desired companion tank mix ingredients. Ammonium salts, anionic surfactants, organic acids, and other components have been found useful to ionically counter balance the polymer blend.

c) Alternately, other compatible functionalities which contribute their expected function to the system may be added as well.

### DETAILED DESCRIPTION OF INVENTION

The use of nitrogen sources such as ammonium sulfate to enhance pesticide, particularly herbicide, performance is well documented. The need for deposition enhancement and resistance to drift is also well documented. The need to enhance potentiation of systemic pesticides is well documented. Other desirable components/features include but are not limited to defoaming agents, surface active agents, potentiating agents, dispersing agents, crystalline inhibitor agents, other dry deposition/anti drift agents, other sequestering agents, shear resistant anti drift agents, etc.

Anti drift/deposition enhancement components such as polyacrylamides, guar, xanthan gums, and other deposition aids are used primarily in a spray mix with pesticides, and most preferably herbicides. It is necessary for those anti drift/deposition formulations to be compatible with a variety of formulation types. Examples of those formulation types are liquid suspension concentrates, dispersible granules and powders, emulsifiable concentrates, and water solutions of organic or inorganic salts. The included surfactant systems in those formulations may consist of anionic, nonionic, and/or cationic surfactants and other components. These pesticide formulations containing surfactant systems may interact in a negative way with anti drift formulations. This may result in the polymers not hydrating properly or forming agglomerates which do not disperse properly causing failure of the anti drift function as well as potentially clogging spray nozzles and screens. Further, there is the potential to interfere with the surfactant activity resulting in reduced efficacy of the pesticide formulation. For example, some new glyphosate formulation exhibit this negative interaction because they are much more highly cationic character than previously commercialized formulations. Traditional polyacrylamide formulations show variation of incompatibility with these new products ranging from inability to spray the tank due to clogged nozzles and screens to questionable field performance of the anti drift function as well as efficacy of the herbicide.

While some anti drift/deposition enhancement formulations have only that single function, most recent products delivered as a part of a multi functional formulation including other functionalities such as sequestering, defoaming, potentiation enhancement, surface activeness, humectancy, anti crystallization, and others.

It would be a significant advancement to develop and deliver an anti drift/deposition enhancement composition containing the above desired characteristics and be compatible with a broad range of ionically charged pesticide, particularly highly cationic herbicide, formulations.

It has been unexpectedly discovered that by balancing the ratio of nonionic and ionic polyacrylamides with an ionically counter balanced diluent, a broad range of compatibility with a wide range of pesticide formulations, particularly highly cationic, can be achieved without sacrificing anti drift/deposition enhancement properties.

It has also been unexpectedly discovered that a wide range of polyacrylamide formulations of differing nonionic and ionic polyacrylamide components having a extremely wide molecular weight ranges show the ability to enhance the activity of certain pesticide, particularly herbicide, formulations. Specifically, glyphosate activity of various salts (isopropyl amine, ammonium and potassium) has been shown to be boosted substantially by the inclusion of the above polyacrylamide formulations to the spray mix.

It has also been unexpectedly discovered that a wide range of electrolyte tolerance can be achieved with nonionic and blends of nonionic/ionic polyacrylamide compounds and nitrogen based diluents such as ammonium salts of nitrates, sulfates, phosphates as well as urea. The ammonium salts include, but are not limited to ammonium sulfate, ammonium chloride, ammonium metaphosphate, ammonium nitrate, diammonium phosphate, monoammonium phosphate, ammonium phosphate nitrate, ammonium phosphate sulfate, ammonium polysulfate, ammonium polyphosphate, ammonium sulfate nitrate, ammonium thiosulfate, ammonium polysulfide, ammonium citrate and urea and mixtures thereof.

The products of this invention include liquid concentrates containing the polyacrylamide, and which may also include one or more other ingredients such as a small amount of nitrogen source, defoamer, sequestering agent, surfactant and the like. The concentrate would then be diluted by mixing 10%-30% of the formula with water to make a ready to use product. The customer would then add the other components such as water, nitrogen source, etc.

Another form of the product is as a liquid ready to use formulation where no dilution is necessary, the water having already been added in an amount sufficient to produce a ready to use formulation.

A dry ready to use product can also be prepared according to the present invention. In this variation, the customer would take the dry ingredients and blend the nitrogen source together with the polymer component to produce the ready to use composition.

Still another variation would involve preparing a dry concentrate with at least the polymer and one other component which then could be blended with the other ingredients at the point of use.

Ready to use emulsions or dispersions in the form of concentrate are also contemplated.

As a dry concentrate, the composition of the present invention include the polyacrylamide polymer as well as one or more of the following:

a) defoamer

b) nitrogen source

c) sequestering agent

d) surfactant

Other substances can also be present to contribute their expected function.

The compositions of the present invention can contain a mixture of non-ionic and anionic polyacrylamide polymer. Typical formulation could contain up to 20% anionic polymer with the balance being non-ionic.

### EXAMPLE 1

I. Manufacturing Procedure

| Raw Material | % |
|---|---|
| TGS 246 polymer concentrate | 1.25 |
| (Anionic polyacrylamide) | |
| AU-319 defoamer concentrate | 1.00 |
| (dimethyl siloxane on sodium acetate) | |
| Ammonium sulfate powder (AMS) | 97.75 |
| Totals | 100 |

B. Raw Materials Receiving Procedure

Upon arrival of raw material, pull an 8 ounce sample for analysis. Perform mandatory Quality Control Tests for unloading. Permit unloading of Raw Material. Perform additional tests as required by Raw Material Specifications.

C. Plant Processing

1. Prescreen AMS powder through a 20 to 30 mesh screen to remove unwanted debris. Charge blender with formula composition above. Mill through a micropulverizer at a rate designed to meet specified particle size. Pass through a screening device with a 30 to 35 mesh screen to remove any large scale from the mill or hopper prior to packaging. Pull sample for quality control analysis. Release for packaging if all parameters meet specifications.

### EXAMPLE 2

I. Manufacturing Procedure

| Raw Material | % |
|---|---|
| TGS 246 polymer concentrate | 0.80 |
| (Anionic polyacrylamide) | |
| AU-319 defoamer | 0.80 |
| Ammonium sulfate powder (AMS) | 99.40 |
| Totals | 100 |

B. Raw Materials Receiving Procedure

Upon arrival of raw material, pull an 8 ounce sample for analysis. Perform mandatory Quality Control Tests for unloading. Permit unloading of Raw Material. Perform additional tests as required by Raw Material Specifications.

C. Plant Processing

1. Premill AMS powder through a 3 TH micropulverizer or equivalent with either no screen in the mill or a large screen such as a Jump Gap screen designed to meet particle size requirements. Pull sample for particle size analysis. If particle size meets specifications, charge proper lbs of AMS milled into ribbon blender. When completely charged, add TGS 246 into the AMS. Blend until uniform. Add other dry components to blender and blend until homogeneous. Pull sample for analysis. Release for packaging if all parameters meet specifications.

### EXAMPLE 3

I. Manufacturing Procedure

| Raw Material | % |
|---|---|
| TGS 246 polymer concentrate | 1.25 |
| AU-319 defoamer concentrate | 1.00 |
| Synfactant urea nonionic clathrate | 25.00 |
| Ammonium sulfate powder (AMS) | 72.75 |
| Totals | 100 |

B. Raw Materials Receiving Procedure

Upon arrival of raw material, pull an 8 ounce sample for analysis. Perform mandatory Quality Control Tests for unloading. Permit unloading of Raw Material. Perform additional tests as required by Raw Material Specifications.

C. Plant Processing

1. Prescreen AMS powder through a 20 to 30 mesh screen to remove unwanted debris. Charge blender with formula composition above. Mill through a micropulverizer at a rate designed to meet specified particle size. Pass through a screening device with a 30 to 35 mesh screen to remove any large scale from the mill or hopper prior to packaging. Pull sample for quality control analysis. Release for packaging if all parameters meet specifications.

### EXAMPLE 4

I. Manufacturing Procedure

| Raw Material | % |
|---|---|
| Water | 95.10 |
| AU-314 defoamer | 0.55 |
| (Dimethyl siloxane emulsion) | |
| Agnique 2069 (Cognis) | 3.00 |
| (alkyl polyglycoside surfactant) | |
| Proxel GXL | 0.05 |
| (preservative) | |
| Magnafloc 351 (Ciba Specialty) | 1.30 |
| (Nonionic polyacrylamide) | |
| Total | 100.00 |

B. Raw Materials Receiving Procedure

Upon arrival of raw material, pull an 8 ounce sample for analysis. Perform mandatory Quality Control Tests for unloading. Permit unloading of Raw Material. Perform additional tests as required by Raw Material Specifications.

C. Plant Processing

1. In the main mixing vessel add in above order all of ingredients accept the Magnafloc 351. Continue agitation and recirculation for 30 minutes minimum after last addition to main vessel. Addition of sodium hydroxide to the top of the tank creates a reaction that is exothermic and solution will heat up slightly. Add increments to bring pH of main vessel into final pH limits. pH cannot be adjusted after polymer is added) Add the Magnafloc 351 via eductor until all is added. Age the mix overnight in aging tank with air sparge. Pull sample for analysis.

2. Release for shipment if all parameters meet specification or adjust accordingly and release upon approval.

### EXAMPLE 5

I. Manufacturing Procedure

| Raw Material | % |
|---|---|
| Water | 32.50 |
| Ammonium sulfate 40% solution | 40.00 |
| Phosphoric Acid 85% | 4.00 |
| Citric Acid solution 50% | 4.00 |
| Sodium Hydroxide 50% | 4.10 |
| Glycerine 99.5% (Cognis) | 10.75 |
| AU-314 defoamer | 0.50 |
| Agnique 2069 (Cognis) | 3.00 |
| Proxel GXL | 0.05 |
| Magnafloc 351 (Ciba Specialty) | 1.10 |
| Totals | 100.00 |

B. Raw Materials Receiving Procedure

Upon arrival of raw material, pull an 8-ounce sample for analysis. Perform mandatory Quality Control Tests for unloading. Permit unloading of Raw Material. Perform additional tests as required by AUI Raw Material Specifications.

C. Plant Processing

1. In the main mixing vessel add in above order all of ingredients except the Magnafloc 351. Continue agitation and recirculation for 30 minutes minimum after last addition to main vessel. Addition of sodium hydroxide to the top of the tank creates a reaction that is exothermic and solution will heat up slightly. Add increments to bring pH of main vessel into final pH limits. pH cannot be adjusted after polymer is added). Add the Magnafloc 351 via eductor until all is added. Age overnight in aging tank with agitation. Pull sample for analysis.

2. Release for shipment if all parameters meet specification or adjust accordingly and release upon approval.

### EXAMPLE 6

I. Manufacturing Procedure

| | Std |
|---|---|
| Raw Material | % |
| Water | 50.65 |
| Glycerin 99.5%-Emery 916 (Cognis) | 10.00 |
| Ammonium sulfate 40% solution | 25.00 |
| 32% nitrogen solution | 3.00 |
| Phosphoric Acid 85% | 2.00 |
| Citric Acid solution 50% | 2.00 |
| Sodium Hydroxide 50% (Caustic soda liq) | 2.80 |
| AU-314 defoamer | 0.40 |
| Agnique 2069 (Cognis) | 2.00 |
| Agnique 2067 (Cognis) | 1.00 |
| Proxel GXL Preservative | 0.05 |
| Magnafloc 156 or 156 F (Ciba Specialty) | 1.10 |
| Totals | 100 |

B. Raw Materials Receiving Procedure

Upon arrival of raw material, pull an 8-ounce sample for analysis. Perform mandatory Quality Control Tests for unloading. Permit unloading of Raw Material. Perform additional tests as required by Raw Material Specifications.

C. Plant Processing

1. In the main mixing vessel add ingredients, in the above order, through the caustic soda. Add the caustic soda cautiously to the top of the tank and pull sample for pH analysis. Note that reaction is exothermic and solution will heat up slightly. Check pH of the solution and adjust as necessary to a pH of 5.0 to 6.5. pH cannot be adjusted after polymer is added to the mix.). Add additional ingredients except the Magnafloc 156. Educt the quantity of Magnafloc 156 with the final solution into the curing tank. Continue agitation overnight or until solution is free from undissolved polymer. Note that 156F will hydrate quicker than 156 due to its small particle size. Pull sample every 30 minutes to check for completion of hydration. Release for shipment if all parameters meet specifications. Pump through filter containing a new 400 micron screen and filter carefully onto truck which is properly cleaned.

### EXAMPLE 7

I. Manufacturing Procedure

| | Std |
|---|---|
| Raw Material | % |
| Water | 50.65 |
| Glycerin 99.5%-Emery 916 (Cognis) | 2.00 |
| Ammonium sulfate 40% solution | 85.00 |
| Phosphoric Acid 85% | 0.40 |
| Citric Acid solution 50% | 0.40 |
| Sodium Hydroxide 50% (Caustic soda liq) | 0.56 |
| AU-314 defoamer | 0.08 |
| Agnique 2069 (Cognis) | 0.40 |
| (alkyl polyglycoside surfactant) | |
| Agnique 2067 (Cognis) | 0.20 |
| (alkyl polyglycoside surfactant) | |
| Proxel GXL Preservative | 0.01 |
| Magnafloc 156 or 156 F (Ciba Specialty) | 0.22 |
| (Anionic polyacrylamide) | |
| Totals | 100 |

B. Raw Materials Receiving Procedure

Upon arrival of raw material, pull an 8-ounce sample for analysis. Perform mandatory Quality Control Tests for unloading. Permit unloading of Raw Material. Perform additional tests as required by Raw Material Specifications.

C. Plant Processing

1. In the main mixing vessel add ingredients, in the above order, through the caustic soda. Add the caustic soda cautiously to the top of the tank and pull sample for pH analysis. Note that reaction is exothermic and solution will heat up slightly. Check pH of the solution and adjust as necessary to a pH of 5.0 to 6.5. pH cannot be adjusted after polymer is added to the mix.). Add additional ingredients except the Magnafloc 156. Educt the quantity of Magnafloc 156 with the final solution into the curing tank. Continue agitation overnight or until solution is free from undissolved polymer. Note that 156F will hydrate quicker than 156 due to its small particle size. Pull sample every 30 minutes to check for completion of hydration. Release for shipment if all parameters meet specifications. Pump through filter containing a new 400 micron screen and filter carefully onto truck which is properly cleaned.

1. An ionically balanced composition for applying to soil or plants comprising an aqueous solution or dry admixture of at least one nonionic acrylamide polymer, and an ionically counterbalanced diluent.

2. The composition according to claim 1, where the ionically counterbalance diluent is a nitrogen source.

3. The composition according to claim 2, wherein the nitrogen containing source is an ammonium salt.

4. The composition according to claim 3, wherein the ammonium salt is a member selected from the group consisting of ammonium sulfate, ammonium chloride, ammonium metaphosphate, ammonium nitrate, diammonium phosphate, monoammonium phosphate, ammonium phosphate nitrate, ammonium phosphate sulfate, ammonium polysulfate, ammonium polyphosphate, ammonium sulfate nitrate, ammonium thiosulfate, ammonium polysulfide, ammonium citrate and urea and mixtures thereof.

5. The composition according to claim 1, wherein the nitrogen containing source is ammonium sulfate.

6. The composition according to claim 1, which additionally contains an anionic or nonionic polymer of acrylamide.

7. The composition according to claim 1, which contains a mixture of nonionic acrylamide polymers and anionic polymers of acrylamide.

8. The composition according to claim 1, wherein the acrylamide polymer is polyacrylamide.

9. The composition according to claim 1, wherein the polymer of acrylamide is a copolymer with up to 20% by weight of an unsaturated comonomer.

10. An aqueous concentrate comprising an aqueous solution of a water soluble nonionic and/or anionic acrylamide polymer and an ionically counterbalanced diluent.

11. The concentrate according to claim 10, in which the solution additionally contains an active ingredient which is a herbicide.

12. The concentrate according to claim 10, wherein the herbicide is glyphosate amine thereof, salt thereof or other water soluable form, phenoxy herbicide as amine or metallic salt as in its free acid form.

13. The concentrate according to claim 10, in which the polymer is formed from 80 to 100% acrylamide and up to 20% ethylenically unsaturated anionic monomer.

14. The concentrate according to claim 10, in which the polymer is a nonionic polyacrylamide, an anionic polyacrylamide or blends thereof.

15. The concentrate according to claim 10, which additionally contains a nitrogen containing source, and optionally a surfactant.

16. A method of making an aqueous concentrate comprising mixing together at least one acrylamide polymer, water and an ionically counterbalanced diluent.

17. The method according to claim 16, which additionally comprises adding a nitrogen containing source to the concentrate, and optionally at least one of a surfactant and a herbicide.

18. A method of applying an ionically balanced composition to soil or a plant comprising spraying an admixture of at least one acrylamide polymer, herbicide, and an ionically counterbalanced diluent and optionally, a surfactant to the soil or plant.

19. The method according to claim 18, where the ionically counterbalanced diluent is a nitrogen source in the composition to be applied to the soil or plant.

20. The method according to claim 19, wherein the nitrogen containing source is an ammonium salt.

21. The method according to claim 20, wherein the ammonium salt is ammonium sulfate.

22. The method according to claim 18, wherein the composition contains a mixture of a nonionic polyacrylamide and an anionic polyacrylamide.
